(19) United States
(12) Patent Application Publication
(10) Pub. No.: US 2026/0212279 A1
(43) Pub. Date: Jul. 23, 2026

(54) SYSTEM AND METHOD FOR CLASSIFYING BEHAVIORS IN SEQUENCE DATA

(71) Applicant: JPMorgan Chase Bank, N.A., New York, NY (US)

(72) Inventors: Maxime KAWAWA-BEAUDAN, New York, NY (US); Srijan SOOD, New York, NY (US); Ganapathy MANI, New York, NY (US); Soham PALANDE, Edison, NJ (US); Tucker Richard BALCH, Suwanee, GA (US); Manuela VELOSO, New York, NY (US); Matthew HOWARD, Pacific Palisades, CA (US); Andrew J SCHRAGER, West Orange, NJ (US); John SIMAK, Staten Island, NY (US); Amos TUWEI, Bloomfield, NJ (US)

(73) Assignee: JPMorgan Chase Bank, N.A., New York, NY (US)

(21) Appl. No.: 19/033,953

(22) Filed: Jan. 22, 2025

(51) Int. Cl. G06N 20/20

(52) U.S. Cl. CPC G06N 20/20

(57) ABSTRACT

Various methods and processes, apparatuses or systems, and media for classifying human behaviors in various domains by using ensemble learning to perform sequence modeling with respect to sequence data are disclosed. The method includes: receiving a first set of data; partitioning the first set of data into a set of respective data streams, each respective data stream corresponding to a respective agent; extracting, from a first data stream, a first sequence of observations that relates to a first agent; inputting the first sequence of observations to each of several models that are trained by using historical data relating to the first agent; using the models to generate a composite score that relates to the first sequence of observations; and determining, based on the composite score, whether the first sequence of observations indicates at least one anomaly that relates to a behavior of the first agent.

### TECHNICAL FIELD

This disclosure relates to methods and apparatuses for classifying human behaviors in various domains by using ensemble learning to perform sequence modeling with respect to sequence data.

### BACKGROUND

The developments described in this section are known to the inventors. However, unless otherwise indicated, it should not be assumed that any of the developments described in this section qualify as prior art merely by virtue of their inclusion in this section, or that these developments are known to a person of ordinary skill in the art.

Modeling human behavior is a complex task with applications spanning multiple domains, such as user research, health card, payments, trading, and e-commerce. Applications range from classifying human activity, distinguishing humans from bots, detecting credit card fraud, etc. Behavior is often captured as sequences of actions or events over time, and understanding patterns within these sequences is crucial for tasks such as classification, anomaly detection, and user modeling. A key challenge in utilizing the captured sequences is class imbalance, where underrepresented behavior profiles or a disproportionate number of anomalous examples hinders model generalization.

Some conventional solutions leverage complex deep learning models, focusing on event-level classification with extensive feature engineering. However, such event-level or feature-aggregated methods may fall short in capturing the sequential dynamics essential for understanding and modeling behavior. These approaches are also susceptible to overfitting, with performance rapidly degrading in class-imbalanced scenarios.

Sequential context is crucial for effective behavior modeling. For example, in credit card fraud detection or anti-money laundering, a user's transaction history may provide deeper insights into behavioral intent than isolated transactions or aggregated features. Yet, many datasets and approaches remain confined to the event level, overlooking the broader sequential context.

Accordingly, there is a need for a mechanism for classifying human behaviors in various domains by using ensemble learning to perform sequence modeling with respect to sequence data.

### SUMMARY

The present disclosure, through one or more of its various aspects, embodiments, and/or specific features or sub-components, provides, among other features, various systems, servers, devices, methods, media, programs, and platforms for classifying human behaviors in various domains by using ensemble learning to perform sequence modeling with respect to sequence data.

According to an aspect of the present disclosure, a method for classifying a human behavior is provided. The method may be implemented by at least one processor. The method may include: receiving a first set of data; partitioning the first set of data into a plurality of respective data streams, each respective data stream corresponding to a respective agent; extracting, from a first data stream from among the plurality of respective data streams, a first sequence of observations that relates to a first agent that corresponds to the first data stream; inputting the first sequence of observations to a first model that is trained by using historical data relating to the first agent; using the first model to generate a composite score that relates to the first sequence of observations; and determining, based on the composite score, whether the first sequence of observations indicates at least one anomaly that relates to a behavior of the first agent.

The first model may be a Hidden Markov Model (HMM).

The first set of data may relate to one from among research data, health care data, payment data, trading data, and e-commerce data.

The partitioning may include performing at least one from among a dimensionality reduction, a tokenization, and a discretization.

The method may further include: training a first plurality of models that includes the first model on a positive class of the historical data, and training a second plurality of models on a negative class of the historical data; inputting the first observational data into each of the first plurality of models, and inputting the first observational data into each of the second plurality of models; and generating the composite score by combining outputs of each of the first plurality of models together with outputs of each of the second plurality of models.

The composite score may represent a number of pairwise comparisons for which each of the first plurality of models assigns a higher likelihood of the at least one anomaly than each of the second plurality of models.

The training of the first plurality of models may be based on a first randomly selected subset of samples of the historical data. The training of the second plurality of models may be based on a second randomly selected subset of samples of the historical data.

The determining of whether the first sequence of observations indicates the at least one anomaly may include using a predetermined threshold value for distinguishing whether the at least one anomaly is indicated.

According to another embodiment, a computing apparatus for classifying a human behavior is provided. The computing apparatus includes a processor; a memory; and a communication interface coupled to each of the processor and the memory. The processor may be configured to: receive, via the communication interface, a first set of data; partition the first set of data into a plurality of respective data streams, each respective data stream corresponding to a respective agent; extract, from a first data stream from among the plurality of respective data streams, a first sequence of observations that relates to a first agent that corresponds to the first data stream; input the first sequence of observations to a first model that is trained by using historical data relating to the first agent; use the first model to generate a composite score that relates to the first sequence of observations; and determine, based on the composite score, whether the first sequence of observations indicates at least one anomaly that relates to a behavior of the first agent.

The first model may be a Hidden Markov Model (HMM).

The first set of data may relate to one from among research data, health care data, payment data, trading data, and e-commerce data.

The partitioning may include performing at least one from among a dimensionality reduction, a tokenization, and a discretization.

The processor may be further configured to: train a first plurality of models that includes the first model on a positive class of the historical data, and train a second plurality of models on a negative class of the historical data; input the first observational data into each of the first plurality of models, and input the first observational data into each of the second plurality of models; and generate the composite score by combining outputs of each of the first plurality of models together with outputs of each of the second plurality of models.

The composite score may represent a number of pairwise comparisons for which each of the first plurality of models assigns a higher likelihood of the at least one anomaly than each of the second plurality of models.

The training of the first plurality of models may be based on a first randomly selected subset of samples of the historical data. The training of the second plurality of models may be based on a second randomly selected subset of samples of the historical data.

The processor may be further configured to determine whether the first sequence of observations indicates the at least one anomaly by using a predetermined threshold value for distinguishing whether the at least one anomaly is indicated.

According to another embodiment, a computing apparatus for classifying a human behavior is provided. The computing apparatus includes a processor; a memory; and a communication interface coupled to each of the processor and the memory. The processor may be configured to: receive a first set of data; partition the first set of data into a plurality of respective data streams, each respective data stream corresponding to a respective agent; extract, from a first data stream from among the plurality of respective data streams, a first sequence of observations that relates to a first agent that corresponds to the first data stream; input the first sequence of observations to a first model that is trained by using historical data relating to the first agent; use the first model to generate a composite score that relates to the first sequence of observations; and determine, based on the composite score, whether the first sequence of observations indicates at least one anomaly that relates to a behavior of the first agent.

When executed, the executable code may further cause the processor to: train a first plurality of models that includes the first model on a positive class of the historical data, and train a second plurality of models on a negative class of the historical data; input the first observational data into each of the first plurality of models, and input the first observational data into each of the second plurality of models; and generate the composite score by combining outputs of each of the first plurality of models together with outputs of each of the second plurality of models.

The composite score may represent a number of pairwise comparisons for which each of the first plurality of models assigns a higher likelihood of the at least one anomaly than each of the second plurality of models.

The training of the first plurality of models may be based on a first randomly selected subset of samples of the historical data. The training of the second plurality of models may be based on a second randomly selected subset of samples of the historical data.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing a method for classifying human behaviors in various domains by using ensemble learning to perform sequence modeling with respect to sequence data, in accordance with an embodiment.

FIG. 2 illustrates an exemplary diagram of a network environment with a device for classifying human behaviors in various domains by using ensemble learning to perform sequence modeling with respect to sequence data, in accordance with an embodiment.

FIG. 3 illustrates a system diagram for implementing a method for classifying human behaviors in various domains by using ensemble learning to perform sequence modeling with respect to sequence data, in accordance with an embodiment.

FIG. 4 illustrates an exemplary flow chart of a process for classifying human behaviors in various domains by using ensemble learning to perform sequence modeling with respect to sequence data, in accordance with an embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

As disclosed herein, a system or method for classifying human behaviors in various domains by using ensemble learning to perform sequence modeling with respect to sequence data may improve the performance of a trained machine learning model by: receiving a first set of sequence data; partitioning the first set of sequence data into a plurality of respective data streams, each respective data stream corresponding to a respective agent; extracting, from a first data stream from among the plurality of respective data streams, a first sequence of observations that relates to a first agent that corresponds to the first data stream; inputting the first sequence of observations to each of several models that are trained by using historical data relating to the first agent; using the models to generate a composite score that relates to the first sequence of observations; and determining, based on the composite score, whether the first sequence of observations indicates at least one anomaly that relates to a behavior of the first agent.

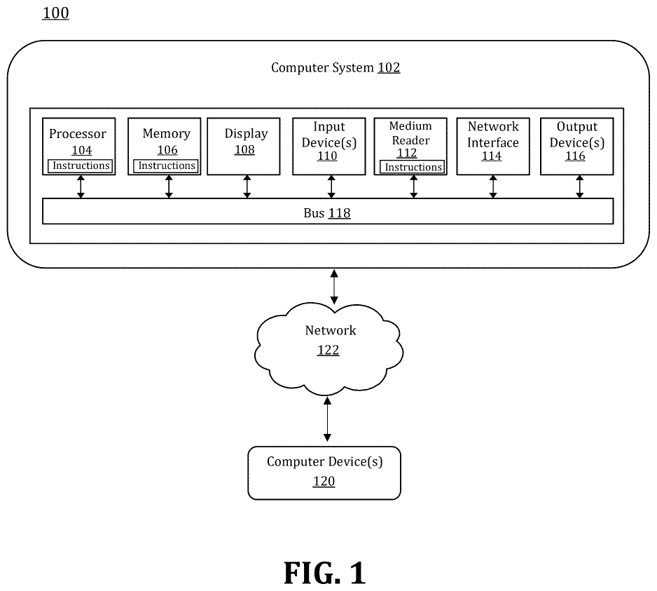

FIG. 1 is an exemplary system 100 for use in implementing a method for classifying human behaviors in various domains by using ensemble learning to perform sequence modeling with respect to sequence data, in accordance with an embodiment. The system 100 is generally shown and may include a computer system 102, which is generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such a cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a GPS device, a visual positioning system (VPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, may be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In some embodiments, the modules implemented by the system 100 may be platform, language, database, and cloud agnostic that may allow for consistent easy orchestration and passing of data through various components to output a desired result regardless of platform, browser, language, database, and cloud environment by writing programs accordingly. The configuration or data files, in some embodiments, may be written using JavaScript Object Notation (JSON), but the disclosure is not limited thereto. For example, the configuration or data files may easily be extended to other readable file formats such as Extensible Markup Language (XML), YAML Ain′t Markup Language (YAML), etc., or any other configuration-based languages.

In accordance with various embodiments of the present disclosure, the methods described herein may be implemented using a hardware computer system that executes software programs. Further, in a non-limited embodiment, implementations can include distributed processing, component/object distributed processing, and an operation mode having parallel processing capabilities. Virtual computer system processing may be constructed to implement one or more of the methods or functionality as described herein, and a processor described herein may be used to support a virtual processing environment.

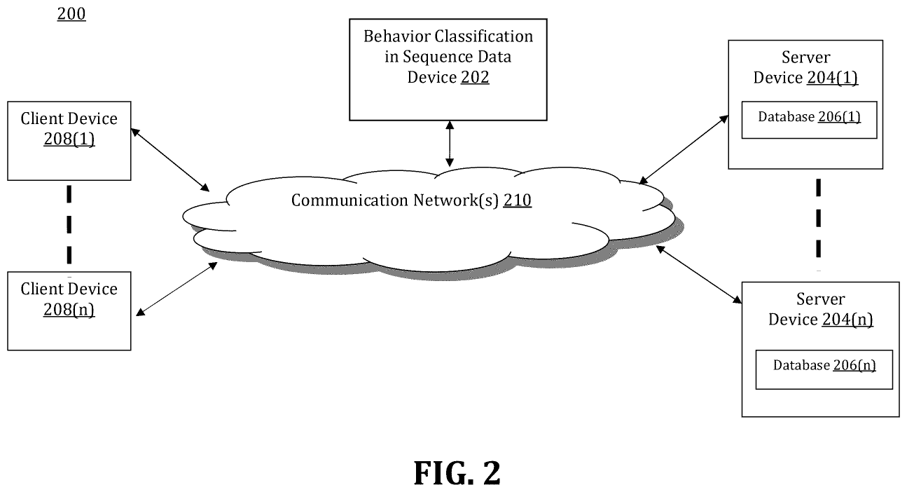

Referring to FIG. 2, a schematic of an exemplary network environment 200 for implementing a behavior classification in sequence data device (BCSDD) of the instant disclosure is illustrated.

In some embodiments, the above-described problems associated with conventional tools may be overcome by implementing a BCSDD 202 as illustrated in FIG. 2 that may be configured for implementing a method for classifying human behaviors in various domains by using ensemble learning to perform sequence modeling with respect to sequence data, but the disclosure is not limited thereto.

The BCSDD 202 may have one or more computer system 102s, as described with respect to FIG. 1, which in aggregate provide the necessary functions.

The BCSDD 202 may store one or more applications that can include executable instructions that, when executed by the BCSDD 202, cause the BCSDD 202 to perform actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the BCSDD 202 itself, may be located in virtual server(s) running in a cloud-based computing environment rather than being tied to one or more specific physical network computing devices. Also, the application(s) may be running in one or more virtual machines (VMs) executing on the BCSDD 202. Additionally, in one or more embodiments of this technology, virtual machine(s) running on the BCSDD 202 may be managed or supervised by a hypervisor.

In the network environment 200 of FIG. 2, the BCSDD 202 is coupled to a plurality of server devices 204(1)-204(n) that hosts a plurality of databases 206(1)-206(n), and also to a plurality of client devices 208(1)-208(n) via communication network(s) 210. A communication interface of the BCSDD 202, such as the network interface 114 of the computer system 102 of FIG. 1, operatively couples and communicates between the BCSDD 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the BCSDD 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The BCSDD 202 may be a standalone device or integrated with one or more other devices or apparatuses, such as one or more of the server devices 204(1)-204(n), for example. In one particular example, the BCSDD 202 may be hosted by one of the server devices 204(1)-204(n), and other arrangements are also possible. Moreover, one or more of the devices of the BCSDD 202 may be in the same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the BCSDD 202 via the communication network(s) 210 according to the HyperText Transfer Protocol (HTTP)-based and/or JSON protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store various types of data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

In some embodiments, the client devices 208(1)-208(n) in this example may include any type of computing device that can facilitate the implementation of the BCSDD 202 that may efficiently provide a platform for implementing a method for classifying human behaviors in various domains by using ensemble learning to perform sequence modeling with respect to sequence data, but the disclosure is not limited thereto.

The client devices 208(1)-208(n) may run interface applications, such as standard web browsers or standalone client applications, which may provide an interface to communicate with the BCSDD 202 via the communication network(s) 210 in order to communicate user requests. The client devices 208(1)-208(n) may further include, among other features, a display device, such as a display screen or touchscreen, and/or an input device, such as a keyboard, for example.

Although the exemplary network environment 200 with the BCSDD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as may be appreciated by those skilled in the relevant art(s).

One or more of the devices depicted in the network environment 200, such as the BCSDD 202, the server devices 204(1)-204(n), or the client devices 208(1)-208(n), for example, may be configured to operate as virtual instances on the same physical machine. For example, one or more of the BCSDD 202, the server devices 204(1)-204(n), or the client devices 208(1)-208(n) may operate on the same physical device rather than as separate devices communicating through communication network(s) 210. Additionally, there may be more or fewer BCSDDs 202, server devices 204(1)-204(n), or client devices 208(1)-208(n) than illustrated in FIG. 2. In some embodiments, the BCSDD 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

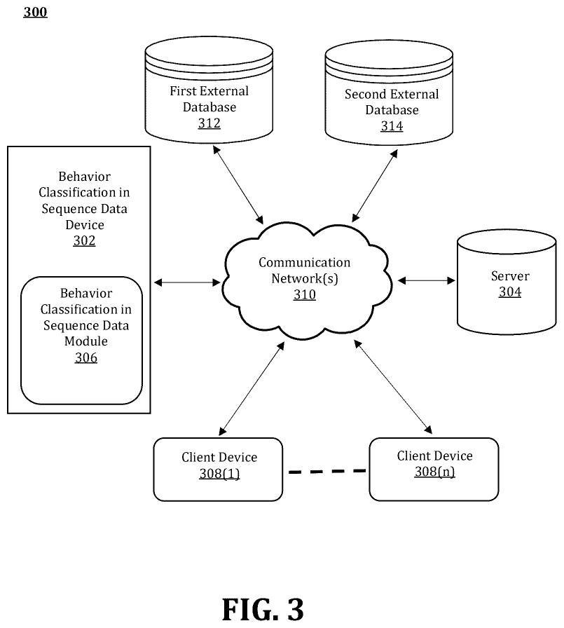

FIG. 3 illustrates a system diagram for implementing a BCSDD 302 having a behavior classification in sequence data module (BCSDM), in accordance with an embodiment.

As illustrated in FIG. 3, the system 300 may include a BCSDD 302 within which a BCSDM 306 is embedded, a server 304, a first external database 312, a second external database 314, a plurality of client devices 308(1) . . . 308(n), and a communication network 310.

In some embodiments, the BCSDD 302 including the BCSDM 306 may be connected to the server 304, and the database(s) 312 via the communication network 310. The BCSDD 302 may also be connected to the plurality of client devices 308(1) . . . 308(n) via the communication network 310, but the disclosure is not limited thereto.

In an embodiment, the BCSDD 302 is described and shown in FIG. 3 as including the BCSDM 306, although it may include other rules, policies, modules, databases, or applications, for example. In some embodiments, the first external database 312 and/or the second external database 314 may be configured to store ready to use modules written for each application programming interface (API) for all environments. Although only one database is illustrated in FIG. 3, the disclosure is not limited thereto. Any number of desired databases may be utilized for use in the disclosed invention herein. The databases 312, 314 may be a mainframe database, a log database that may produce programming for searching, monitoring, and analyzing machine-generated data via a web interface, etc., but the disclosure is not limited thereto.

In some embodiments, the BCSDM 306 may be configured to receive real-time feed of data from the plurality of client devices 308(1) . . . 308(n) and secondary sources via the communication network 310.

As may be described below, the BCSDM 306 may be configured to: receive a first set of sequence data; partition the first set of sequence data into a plurality of respective data streams, each respective data stream corresponding to a respective agent; extract, from a first data stream from among the plurality of respective data streams, a first sequence of observations that relates to a first agent that corresponds to the first data stream; input the first sequence of observations to each of several models that are trained by using historical data relating to the first agent; use the models to generate a composite score that relates to the first sequence of observations; and determine, based on the composite score, whether the first sequence of observations indicates at least one anomaly that relates to a behavior of the first agent, but the disclosure is not limited thereto.

The plurality of client devices 308(1) . . . 308(n) are illustrated as being in communication with the BCSDD 302. In this regard, the plurality of client devices 308(1) . . . 308(n) may be “clients” (e.g., customers) of the BCSDD 302 and are described herein as such. Nevertheless, it is to be known and understood that the plurality of client devices 308(1) . . . 308(n) need not necessarily be “clients” of the BCSDD 302, or any entity described in association therewith herein. Any additional or alternative relationship may exist between either or both of the plurality of client devices 308(1) . . . 308(n) and the BCSDD 302, or no relationship may exist.

The first client device 308(1) may be, for example, a smart phone. Of course, the first client device 308(1) may be any additional device described herein. The second client device 308(n) may be, for example, a personal computer (PC). Of course, the second client device 308(n) may also be any additional device described herein. In some embodiments, the server 304 may be the same or equivalent to the server device 204 as illustrated in FIG. 2.

The process may be executed via the communication network 310, which may comprise plural networks as described above. For example, in an embodiment, one or more of the plurality of client devices 308(1) . . . 308(n) may communicate with the BCSDD 302 via broadband or cellular communication. Of course, these embodiments are merely exemplary and are not limiting or exhaustive.

The computing device 301 may be the same or similar to any one of the client devices 208(1)-208(n) as described with respect to FIG. 2, including any features or combination of features described with respect thereto. The BCSDD 302 may be the same or similar to the BCSDD 202 as described with respect to FIG. 2, including any features or combination of features described with respect thereto.

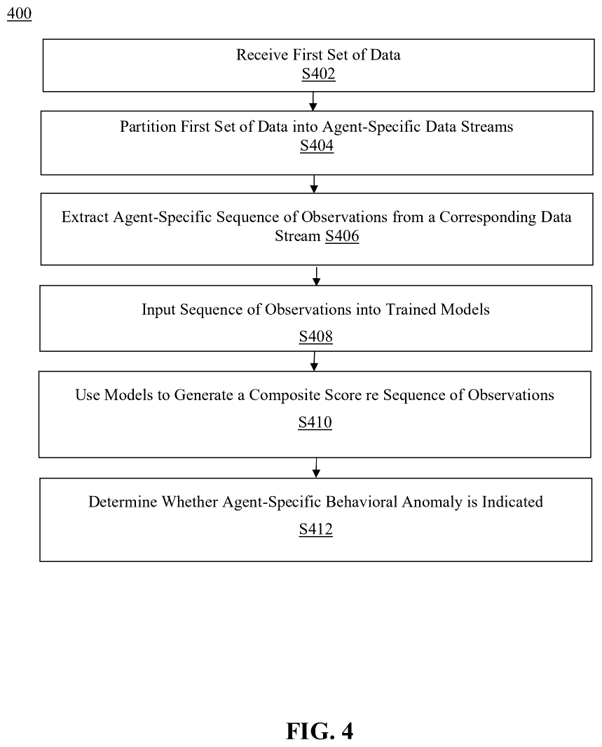

FIG. 4 illustrates an exemplary flow chart of a process 400 implemented by the BCSDM 306 of FIG. 3 for enablement of a system and a method for classifying human behaviors in various domains by using ensemble learning to perform sequence modeling with respect to sequence data, in accordance with an embodiment. It may be appreciated that the illustrated process 400 and associated steps may be performed in a different order, with illustrated steps omitted, with additional steps added, or with a combination of reordered, combined, omitted, or additional steps.

As illustrated in FIG. 4, at step S402, the process 400 may include receiving a first set of data. In an embodiment, the data may relate to any one or more of research data, health care data, payment data, trading data, e-commerce data, and/or any other suitable type of data that is obtainable over a period of time.

At step S404, the process 400 may include partitioning the first set of data into a set of respective data streams that correspond to respective agents, i.e., individual persons. For example, if the first set of data is health care data that is obtained from a hospital over a period of time, then the agents may include patients and health care providers, such as doctors and nurses; and the first set of data may be partitioned into agent-specific data streams such that a first data stream corresponds to a first individual patient, a second data stream corresponds to a second individual patient, and so forth, up to n patients; and an (n+1)th data stream corresponds to a first health care provider, an (n+2)th data stream corresponds to a second health care provider, and so forth, up to m health care providers. In an embodiment, the partitioning operation may include any one or more of a dimensionality reduction operation, a tokenization operation, and/or a discretization operation.

At step S406, the process 400 may include extracting a first sequence of observations from a respective agent-specific data stream in order to obtain observations that relate to a particular agent. Then, at step S408, the process 400 may include inputting the first sequence of observations into one or more models that have been trained by using historical data that relates to the particular agent.

In an embodiment, each of the models is a Hidden Markov Model (HMM), and the models may be divided into two sets of models-a first set of HMMs, each of which is trained on a positive class of the historical data, and a second set of HMMs, each of which is trained on a negative class of the historical data. In an embodiment, each of the HMMs may be trained on a randomly selected subset of the historical data. In this aspect, by using different sets of training data that are randomly selected from a single superset of historical data, there is an increased probability that different models will generate a diversity of outputs, which results in a more robust overall output. However, it is noted that the process 400 is not limited to the use of HMMs, and in other embodiments, other model classes may be used, such as, for example, models that implement machine learning methods, such as support vector machines (SVMs) and random forest models; and models that implement deep-learning methods, such as long short-term memory (LSTM) networks and Transformer models.

At step S410, the process 400 may include using the models to generate a composite score that relates to the first sequence of operations. In an embodiment, the composite score may be generated by combining respective scores that are generated by each individual model. In an embodiment, each respective score that is generated by a corresponding model may relate to a likelihood that the first sequence of operations indicates a behavioral anomaly that relates to a behavior of the particular agent that corresponds to the first sequence of operations, and the composite score may represent a number of pairwise comparisons for which each of the first set of HMMs assigns a higher likelihood of a presence of an anomaly than a likelihood thereof that is assigned by each of the second set of HMMs. However, it is again noted that the process 400 is not limited to the use of HMMs, and in other embodiments, other model classes may be used, such as, for example, SVMs, random forest models, LSTM networks, and Transformer models.

At step S412, the process 400 may include determining, based on the composite score generated in step S410, whether the first sequence of observations indicates at least one anomaly that relates to a behavior of the particular agent. In an embodiment, the determination may be based on a result of a comparison of the composite score with a predetermined threshold value for distinguishing whether the presence of the at least one anomaly is indicated.

In an embodiment, a system and a method for classifying human behaviors in various domains by using ensemble learning to perform sequence modeling with respect to sequence data is provided. This methodology is particularly useful for scenarios where behaviors are represented as action sequences derived from unstructured data. Aggregating such data into coherent sequences that reflect an agent's decision-making process is a non-trivial challenge. In an embodiment, the methodology entails the use of a lightweight ensemble-based framework for behavior modeling that is efficacious for various types of sequence classification tasks, including those that may involve imbalanced sequences that correspond to variable lengths of time.

In an embodiment, the methodology entails the use of a behavior modeling framework that is based on sequences of events and/or actions, is applicable to various domains, and is also applicable to both supervised and unsupervised tasks. In an embodiment, although the methodology is model-agnostic, Hidden Markov Models (HMMs) may be employed, in order to leverage their simplicity, interpretability, and efficacy at capturing temporal dependencies and latent patterns. HMMs are statistical models for sequential data, which have a long history of use in natural language processing, finance, and bioinformatics. HMMs have been used extensively for behavior modeling, including sensor surveillance, human-computer interfaces, web user interactions, and social media bot detection. While neural network-based approaches such as convolutional neural networks (CNNs), long-term short memory (LSTM) networks, and Transformers have shown success in settings such as sentiment analysis and network intrusion detection, they face challenges such as high computational cost, overfitting, and reduced interpretability.

Event-level classification still dominates in areas such as anti-money laundering and network security, where sequence-level labels may be missing. This lends itself to aggregate feature based approaches, which may miss important historical context.

Many real-world problems such as intrusion detection, credit card fraud, and money laundering involve detecting rare events and suffer from class imbalance. One-class anomaly detection focuses on robustly modeling the nominal class and identifying deviations, while more targeted approaches model both normal and anomalous sequences to detect specific behavioral anomalies.

In an embodiment, consideration may be given to a sequence observation [symbol] ={a₁, a₂, . . . , a_{T}}, where each (is drawn from a discrete set of actions [symbol] . Such sequences can represent various behaviors, such as user interactions in an application, trading actions in financial markets, or other human decision-making processes. An objective is to model these behaviors, either discovering behavior clusters, or classifying behaviors where labels are available (e.g., online bot detection, credit card fraud detection, or physical activity recognition).

In an embodiment, one of the primary challenges lies in organizing coherent data streams from raw, fragmented data [symbol] , which may contain interwoven behaviors from multiple agents/users. For instance, in trading, [symbol] may span billions of transactions across participants, assets, and exchanges, thus requiring grouping data streams by participant, and further by exchange or asset, in order to capture specific behaviors. In network analysis, interactions between devices and servers can be grouped by source Internet Protocol (IP) for individual user activity, or further by target IP to constitute specific behavior streams.

In an embodiment, a partitioning operation is performed in order to disentangle [symbol] into separate data streams [symbol] ₁, . . . [symbol] _{H}, each corresponding to one of H agents. Feature engineering refines these data streams through dimensionality reduction, tokenization, and/or discretization, thereby enhancing model generalization, particularly in the presence of imbalanced or sparse datasets. Continuous features may also be normalized and estimated directly, through techniques such as Gaussian HMMs.

In an embodiment, once the data is organized into streams [symbol] ₕ, sequences of observations

$${𝒪}_{h}^{( 1 )} , … , {𝒪}_{h}^{( n [ h ] )}$$

may then be extracted from each stream, with domain knowledge or sessions guiding the sequence span, i.e., start points and end points. For example, web user behavior may span minutes to hours, whereas medical trial observations could extend over days or weeks. Breaks in continuous data streams often demarcate sequences, with shorter pauses treated as wait events and longer breaks as sequence endpoints. The number of sequences may vary significantly across agents, thereby reflecting differing activity levels (e.g., power users versus intermittent monthly users).

In an embodiment, considering binary sequence classification, training data may be separated by class and used to train two individual HMMs: one positive class HMM λ+ and one negative class HMM λ−. Given an unseen sequence [symbol] , the predicted class c( [symbol] ) may be determined by comparing the likelihoods, as expressed in Equation 1 below:

$$c ( 𝒪 ) = \text{?} \{ p ( 𝒪 \vert {λ}^{+} ) > p ( 𝒪 \vert {λ}^{-} ) \} \qquad ( 1 )$$

HMMs excel at sequence analysis but may struggle when comparing sequences of variable length, as length influences likelihood computation exponentially. In an embodiment, this may be addressed through model-driven normalization, computing likelihoods for a given sequence across multiple models, and deriving a rank-based composite score, rather than comparing sequence likelihoods.

HMMs, while lightweight and efficient, may struggle to capture the complexity of behaviors in training data when using a singular model per class. In an embodiment, ensemble methods train multiple models on subsets of the data, thereby enabling each learner to specialize on distinct patterns or behaviors, while collectively capturing the full data distribution. This results in a more robust approach, particularly in scenarios with data imbalance, where monolithic models may skew toward modeling the majority class or underfitting for class-specific models. In an embodiment, an ensemble framework that computes composite scores from individual learners is employed. While HMMs are effective, this framework is model-agnostic and may incorporate other model frameworks such as neural networks, support vector machines (SVMs), or decision trees.

In an embodiment, N models

$$\{ {λ}_{1}^{+} , … , {λ}_{N}^{+} \}$$

are trained on the positive class, and M models

$$\{ {λ}_{1}^{-} , … , {λ}_{M}^{-} \}$$

are trained on the negative class, taking care to ensure diversity among the models by training each on a randomly selected subset of samples from the training data. Each model sees s % of the training data in its relevant class. While N and M may be set such that N=M, the parameters (N, M, s) may be established by using typical hyperparameter optimization approaches. For any given sequence in the training data, the probability of not being selected for any model's random subset is (1−s)^{N}. The expected number of unsampled sequences is the same, so it is important to select s and N to keep this proportion of the data relatively small.

In an embodiment, for an unseen observation sequence [symbol] , its likelihood scores may be computed under all models:

$$\begin{matrix}\{ p ( 𝒪 \vert {λ}_{1}^{+} ) , … , p ( 𝒪 \vert {λ}_{N}^{+} ) \} and \\ \{ p ( 𝒪 \vert {λ}_{1}^{-} \} , … , p ( 𝒪 \vert {λ}_{M}^{-} ) \} .\end{matrix}$$

A composite score may then be computed in accordance with Equation 2 below:

$$s ( 𝒪 ) = {{\sum }^{N}}_{i = 1} {{\sum }^{M}}_{j = 1} \text{?} \{ p ( 𝒪 \vert {λ}_{i}^{+} ) > p ( 𝒪 \vert {λ}_{j}^{-} ) \} \qquad ( 2 )$$

The score s( [symbol] ) represents the pairwise comparisons where positive-class models assign a higher likelihood than negative-class models, taking values in [0, N×M]. A low score indicates that the sequence is more likely under the negative-class models, and a high score indicates that the sequence is more likely under the positive-class models. As likelihoods across different sequence lengths are not directly compared, this composite score acts as an implicit normalization technique. N and M may be chosen such that the score range adequately distinguishes the classes.

In an embodiment, three states may be used in each model, and an ensemble size of 250 and a subset factor of 1% may be used. Alternatively, other ensemble sizes may be used, such as 10, 50, 100, 500, 1000, or any other suitable ensemble size. In an embodiment, an ensemble size of 250 balances relatively good performance with relatively low complexity.

Given a corpus of sequences and corresponding scores { [symbol] , s( [symbol] )}, sequences may be classified using a threshold sₜₕᵣₑₛₕ: c( [symbol] ᵢ)= [symbol] {s( [symbol] ᵢ)≥sₜₕᵣₑₛₕ}. Alternatively, base learner likelihoods can server as features for downstream classifiers. For each sequence [symbol] ᵢ, a feature vector may be defined in accordance with Equation 3 below:

$${f}_{i} = \{ p ( {𝒪}_{i} \vert {λ}_{1}^{+} \} , … , p ( {O}_{i} \vert {λ}_{N}^{+} ) , p ( {𝒪}_{i} \vert {λ}_{1}^{-} ) , … , p ( {𝒪}_{i} \vert {λ}_{M}^{-} ) ] \qquad ( 3 )$$

In an embodiment, to account for sequence length sensitivity, fᵢ may be normalized by ∥fᵢ∥₂. This technique utilizes HMMs as feature extractors, where each feature p( [symbol] ᵢ|λⱼ) represents a similarity between the sequence [symbol] ᵢ and the random subset of training data underlying λⱼ.

In an embodiment, in label-free settings, behavior clustering may be achieved by using unsupervised learning approaches. N models {λ₁, . . . , λ_{N}} may be trained on random s % data subsets, and feature vectors of base learner likelihoods fᵢ may be generated. Unsupervised clustering such as K-Means can be applied to discover behavioral groups, and dimensionality reduction may be helpful when Nis large.

In some embodiments as disclosed above in FIGS. 1-4, technical improvements effected by the instant disclosure may include a platform for implementing a behavior classification in sequence data module configured for enablement of classifying human behaviors in various domains by using ensemble learning to perform sequence modeling with respect to sequence data, but the disclosure is not limited thereto.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium may be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, may be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for classifying a human behavior, the method being implemented by at least one processor, the method comprising:
receiving a first set of data;
partitioning the first set of data into a plurality of respective data streams, each respective data stream corresponding to a respective agent;
extracting, from a first data stream from among the plurality of respective data streams, a first sequence of observations that relates to a first agent that corresponds to the first data stream;
inputting the first sequence of observations to a first model that is trained by using historical data relating to the first agent;
using the first model to generate a composite score that relates to the first sequence of observations; and
determining, based on the composite score, whether the first sequence of observations indicates at least one anomaly that relates to a behavior of the first agent.

2. The method of claim 1, wherein the first model is a Hidden Markov Model (HMM).

3. The method of claim 1, wherein the first set of data relates to one from among research data, health care data, payment data, trading data, and e-commerce data.

4. The method of claim 1, wherein the partitioning comprises performing at least one from among a dimensionality reduction, a tokenization, and a discretization.

5. The method of claim 1, further comprising:
training a first plurality of models that includes the first model on a positive class of the historical data, and training a second plurality of models on a negative class of the historical data;
inputting the first observational data into each of the first plurality of models, and inputting the first observational data into each of the second plurality of models; and
generating the composite score by combining outputs of each of the first plurality of models together with outputs of each of the second plurality of models.

6. The method of claim 5, wherein the composite score represents a number of pairwise comparisons for which each of the first plurality of models assigns a higher likelihood of the at least one anomaly than each of the second plurality of models.

7. The method of claim 5, wherein the training of the first plurality of models is based on a first randomly selected subset of samples of the historical data, and wherein the training of the second plurality of models is based on a second randomly selected subset of samples of the historical data.

8. The method of claim 1, wherein the determining of whether the first sequence of observations indicates the at least one anomaly comprises using a predetermined threshold value for distinguishing whether the at least one anomaly is indicated.

9. A computing apparatus for classifying a human behavior, the computing apparatus comprising:
a processor;
a memory; and
a communication interface coupled to each of the processor and the memory,
wherein the processor is configured to:
receive, via the communication interface, a first set of data;
partition the first set of data into a plurality of respective data streams, each respective data stream corresponding to a respective agent;
extract, from a first data stream from among the plurality of respective data streams, a first sequence of observations that relates to a first agent that corresponds to the first data stream;
input the first sequence of observations to a first model that is trained by using historical data relating to the first agent;
use the first model to generate a composite score that relates to the first sequence of observations; and
determine, based on the composite score, whether the first sequence of observations indicates at least one anomaly that relates to a behavior of the first agent.

10. The computing apparatus of claim 9, wherein the first model is a Hidden Markov Model (HMM).

11. The computing apparatus of claim 9, wherein the first set of data relates to one from among research data, health care data, payment data, trading data, and e-commerce data.

12. The computing apparatus of claim 9, wherein the partitioning comprises performing at least one from among a dimensionality reduction, a tokenization, and a discretization.

13. The computing apparatus of claim 9, wherein the processor is further configured to:
train a first plurality of models that includes the first model on a positive class of the historical data, and train a second plurality of models on a negative class of the historical data;
input the first observational data into each of the first plurality of models, and input the first observational data into each of the second plurality of models; and
generate the composite score by combining outputs of each of the first plurality of models together with outputs of each of the second plurality of models.

14. The computing apparatus of claim 13, wherein the composite score represents a number of pairwise comparisons for which each of the first plurality of models assigns a higher likelihood of the at least one anomaly than each of the second plurality of models.

15. The computing apparatus of claim 13, wherein the training of the first plurality of models is based on a first randomly selected subset of samples of the historical data, and wherein the training of the second plurality of models is based on a second randomly selected subset of samples of the historical data.

16. The computing apparatus of claim 9, wherein the processor is further configured to determine whether the first sequence of observations indicates the at least one anomaly by using a predetermined threshold value for distinguishing whether the at least one anomaly is indicated.

17. A non-transitory computer readable storage medium storing instructions for classifying a human behavior, the storage medium comprising executable code which, when executed by a processor, causes the processor to:
receive a first set of data;
partition the first set of data into a plurality of respective data streams, each respective data stream corresponding to a respective agent;
extract, from a first data stream from among the plurality of respective data streams, a first sequence of observations that relates to a first agent that corresponds to the first data stream;
input the first sequence of observations to a first model that is trained by using historical data relating to the first agent;
use the first model to generate a composite score that relates to the first sequence of observations; and
determine, based on the composite score, whether the first sequence of observations indicates at least one anomaly that relates to a behavior of the first agent.

18. The storage medium of claim 17, wherein when executed, the executable code further causes the processor to:
train a first plurality of models that includes the first model on a positive class of the historical data, and train a second plurality of models on a negative class of the historical data;
input the first observational data into each of the first plurality of models, and input the first observational data into each of the second plurality of models; and
generate the composite score by combining outputs of each of the first plurality of models together with outputs of each of the second plurality of models.

19. The storage medium of claim 18, wherein the composite score represents a number of pairwise comparisons for which each of the first plurality of models assigns a higher likelihood of the at least one anomaly than each of the second plurality of models.

20. The storage medium of claim 19, wherein the training of the first plurality of models is based on a first randomly selected subset of samples of the historical data, and wherein the training of the second plurality of models is based on a second randomly selected subset of samples of the historical data.
